(19) United States
(12) Patent Application Publication
(10) Pub. No.: US 2009/0134820 A1
(43) Pub. Date: May 28, 2009

(54) Drive unit for vehicle

(75) Inventors: Masataka Sugiyama, Toyota-shi (JP); Masato Adachi, Nishikamo-gun (JP); Haruhisa Suzuki, Nishikamo-gun (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi (JP)

(21) Appl. No.: 12/292,106

(22) Filed: Nov. 12, 2008

(30) Foreign Application Priority Data
Nov. 28, 2007 (JP) 2007-307858

(51) Int. Cl. H02P 5/00; H02P 1/04

(52) U.S. Cl. 318/66; 318/400.09; 180/65.285

(57) ABSTRACT

A vehicle drive unit that includes a first rotary machine; an electric differential; a second rotary machine that transmits power from the electric differential to wheels via a first power transmission interrupt mechanism; a second power transmission interrupt mechanism that connects the second rotary machine to an input member of the electric differential; and a control device. The control device switches between a first operation mode, in which the first power interruption mechanism is in a power transmitting state and the second power interruption mechanism is in a power disconnected state, and a second operation mode, in which the first power interruption mechanism in a power disconnected state and the second power interruption mechanism in a power transmitting state. To avoid generation of a shock, the operation mode is switched when the torque of the second rotary machine is nearly 0.

### INCORPORATION BY REFERENCE

The disclosure of Japanese Patent Application No. 2007-307858 filed on Nov. 28, 2007 including the specification, drawings and abstract is incorporated herein by reference in its entirety.

### BACKGROUND OF THE INVENTION

1. Field of the Invention

The present invention relates to a drive unit for a vehicle, and, more particularly, to a technique in a vehicle equipped with first and second rotary machines to reduce the shock that may occur in a vehicle equipped with first and second rotary machines when two operation modes that the rotary machines have different operating conditions are switched from one to the other.

2. Description of the Related Art

A drive unit for a vehicle is known, having: an electric differential in which the differential state between input and output rotational speeds is controlled when the operating conditions of a first rotary machine connected to a reaction force element thereof is controlled; and a second rotary machine connected to the power transmission route from an output member of the electric differential to wheels via a first power transmission interrupt mechanism for transmission of power (see Japanese Patent Application Publication No. 2005-212494 (JP-A-2005-212494)).

FIG. 12 is a general configuration diagram of a hybrid drive unit 100 for a vehicle as an example of such a drive unit for a vehicle, in which the torque of a first drive force generation source 12 as a main drive source is transmitted to an output shaft 14 which functions as an output member, and then transmitted from the output shaft 14 to a pair of right and left driving wheels 18 via a differential gear device 16. The hybrid drive unit 100 also has a second motor generator MG2, as a second drive force generation source, which selectively performs a powering operation to output drive force to propel the vehicle and an electricity generating operation to recover energy. The second motor generator MG2 is connected to the output shaft 14 via an automatic transmission 22. Therefore, the torque capacity transmitted from the second motor generator MG2 to the output shaft 14 is increased or decreased depending on the transmission gear ratio γs (=rotational speed NMG2 of MG2/rotational speed N_{OUT} of the output shaft 14) set in the automatic transmission 22. The second motor generator MG2 corresponds to a second rotary machine.

The first drive force generation source 12 is constituted essentially of an engine 24; a first motor generator MG1; and a planetary gear device 26 that combines or distributes torque between the engine 24 and the first motor generator MG1. The engine 24 is a conventional internal combustion engine, which burns fuel to output power, such as a gasoline or diesel engine. The operating conditions, such as throttle valve opening, intake air amount, fuel supply amount, and ignition timing, of the engine 24 are electrically controlled by an electronic control device (E-ECU) 28 for engine control constituted essentially of a microcomputer. The electronic control device 28 receives detection signals from an accelerator operation amount sensor AS that detects the operation amount θACC of an accelerator pedal 27, a brake sensor BS that detects whether a brake pedal 29 is being operated, an engine speed sensor 50 that detects the engine speed NE and so on.

The first motor generator MG1 is configured to selectively function as an electric motor, which generates driving torque, and as a generator. The first motor generator MG1 and is connected to an electric storage device 32, such as a battery or capacitor, via an inverter 30. The inverter 30 is controlled by an electronic control device (MG-ECU) 34 for motor generator control constituted essentially of a microcomputer, whereby the output torque or electricity generating torque (regenerating torque) of the first motor generator MG1 is adjusted or set. The electronic control device 34 receives detection signals from an operational position sensor SS that detects the operational position of a shift lever 35; an MG1 rotational speed sensor 48 that detects the rotational speed NMG1 of the first motor generator MG1 and so on. The first motor generator MG1 corresponds to a first rotary machine.

The planetary gear device 26, which has a sun gear S0; a ring gear R0 disposed concentrically about the sun gear S0; and a carrier CA0 that supports a pinion gear in meshing engagement with the sun gear S0 and the ring gear R0 for rotation on its own axis and orbital rotation as three rotational elements, is a single-pinion planetary gear mechanism which provides a well-known differential action. The planetary gear device 26 is disposed concentrically with the engine 24 and the automatic transmission 22. Because the planetary gear device 26, the automatic transmission 22, the first motor generator MG1, and the second motor generator MG2 are all generally symmetric with respect to a central axis, the lower halves below the center line are omitted in FIG. 12.

The engine 24 has a crankshaft 36 connected to the carrier CA0 of the planetary gear device 26 via a damper 38 and an input shaft 25. The first motor generator MG1 is connected to the sun gear S0, and the output shaft 14 is connected to the ring gear R0. The carrier CA0 functions as an input element, the sun gear S0 functions as a reaction force element, and the ring gear R0 functions as an output element. When the operating conditions of the first motor generator MG1 connected to the sun gear S0 as a reaction force element are controlled, the differential state between the input rotational speed, i.e., the engine speed NE and the output rotational speed, i.e., output shaft rotational speed N_{OUT} is controlled. An electric differential 20 is constituted of the first motor generator MG1 and the planetary gear device 26, and the input shaft 25 and the output shaft 14 correspond to an input member and an output member, respectively. The connection relation of the planetary gear device 26 can be changed as needed, and a double-pinion planetary gear device may be used as the planetary gear device 26.

The relative relation among the rotational speeds of the rotational elements of the single-pinion planetary gear device 26, which functions as a torque combining-distributing mechanism, is shown in collinear diagram of FIG. 13. In the collinear diagram, a vertical axis S0, a vertical axis CA0, and a vertical axis R0 represents the rotational speed of the sun gear S0, the rotational speed of the carrier CA0, and the rotational speed of the ring gear R0, respectively, and the distances between the vertical axis S0, the vertical axis CA0, and the vertical axis R0 are set such that the distance between the vertical axis CA0, and the vertical axis R0 represents a gear ratio ρ (the number ZS of teeth of the sun gear S0/the number ZR of teeth of the ring gear R0), assumed that the distance between the vertical axis S0 and the vertical axis CA0 is defined as 1.

In the planetary gear device 26, when a reaction force torque generated by the first motor generator MG1 is input to the sun gear S0 against the output torque TE of the engine 24 input to the carrier CA0, a torque greater than the torque TE input from the engine 24 is applied to the ring gear R0 as an output element. Also, when the rotational speed (output shaft rotational speed) N_{OUT} of the ring gear R0 is constant, the rotational speed NE of the engine 24 can be varied continuously (in a stepless manner) by increasing or decreasing the rotational speed NMG1 of the first motor generator MG1. That is, the transmission gear ratio γo (=NE/N_{OUT}) of the engine speed NE to the output shaft rotational speed N_{OUT} can be varied in a stepless manner by controlling the rotational speed NMG1 of the first motor generator MG1. The broken line in FIG. 13 shows the state in which the rotational speed NE of the engine 24 decreases when the rotational speed NMG1 of the first motor generator MG1 is reduced from the value shown by a solid line. Therefore, control to set the rotational speed NE of the engine 24 to a rotational speed, which provides the best fuel efficiency, can be performed by controlling the first motor generator MG1. The hybrid system of this type is called “mechanical distribution type” or “split type.”

Referring again to FIG. 12, the automatic transmission 22 is constituted essentially of a planetary gear mechanism having a stepped pinion P1 having a small-diameter portion and a large-diameter portion. The stepped pinion P1 is supported by a carrier CA1 for rotation on its own axis and orbital rotation. A first sun gear S1 and the ring gear R1 are in meshing engagement with the large-diameter portion, and a second sun gear S2 is in meshing engagement with the small-diameter portion. The first sun gear S1 is connected to the second motor generator MG2, and the carrier CA1 is connected to the output shaft 14. The electronic control device (MG-ECU) 34 for motor generator control controls the second motor generator MG2 via an inverter 40 to cause the second motor generator MG2 to function as an electric motor or generator and to control the powering torque (i.e. torque output) and the electricity generating torque (regeneration torque) thereof. The electronic control device 34 is supplied with a detection signal from an MG2 rotational speed sensor 46 that detects the rotational speed NMG2 of the second motor generator MG2.

The automatic transmission 22 has a first brake B1 which is disposed between the second sun gear S2 and a transmission housing 42 to selectively fix the second sun gear S2, and a second brake B2 disposed between the ring gear R1 and the transmission housing 42 to selectively fix the ring gear R1. Each of the brakes B1 and B2 is what is called a hydraulic friction engaging device which uses frictional force to generate an engaging force, and may be a multi-plate engaging device or a band-type engaging device. Each of the brakes B1 and B2 has a torque capacity which varies continuously according to the engaging pressure generated by a hydraulic actuator or the like, and is engaged and disengaged via a hydraulic pressure control device (not shown).

In the automatic transmission 22 constituted as described above, the first sun gear S1 functions as an input element and the carrier CA1 functions as an output element. When the first brake B1 is engaged, a high gear Hi with a transmission gear ratio γsh greater than “1” is established. When the second brake B2 is engaged instead of the first brake B1, a low gear Lo with a transmission gear ratio γsl which is greater than the transmission gear ratio γsh of the high gear Hi is established. When the first brake B1 and the second brake B2 are both disengaged, the second motor generator MG2 is disconnected from the output shaft 14 to establish a disconnected state in which the transmission of power is cut off. The shift between the gears Hi and Lo is carried out based on a running condition such as the vehicle speed V, the accelerator operation amount θACC, or the requested drive force. More specifically, gear ranges are determined as a map (shift diagram), and one of the gears is selected depending on the detected running condition. The first brake B1 and the second brake B2 correspond to a first power transmission interrupt mechanism.

FIG. 14 is a collinear diagram having four vertical axes, i.e., vertical axis S1, vertical axis CA1, vertical axis R1, and vertical axis S2 for the rotational elements of the planetary gear mechanism constituting the automatic transmission 22, each representing the rotational speed of the first sun gear S1, the rotational speed of the carrier CA1, the rotational speed of the ring gear R1, and the rotational speed of the second sun gear S2, respectively, and showing the relation between the output shaft rotational speeds N_{OUT} in the gears Hi and Lo and the rotational speed NMG2 of the second motor generator MG2. That is, the output shaft rotational speeds N_{OUT} in the gears Hi and Lo, based on the assumption that the rotational speed NMG2 of the second motor generator MG2 is constant, are shown for comparison. When the first brake B1 is engaged and the high gear Hi is established, the output shaft rotational speed N_{OUT} becomes a rotational speed (=NMG2/γsh) indicated as “Hi.” When the second brake B2 is engaged and the low gear Lo is established, the output shaft rotational speed N_{OUT} becomes a rotational speed (=NMG2/γsl) indicated as “Lo.”

An electronic control device (T-ECU) 44 for gearshift control constituted essentially of a microcomputer is provided to perform the above gearshift control, and engages and disengages the brakes B1 and B2 via a hydraulic pressure control device. The electronic control device 44 is supplied with a detection signal from an output shaft rotational speed sensor 52 that detects the rotational speed N_{OUT} of the output shaft 14 which corresponds to the vehicle speed V, and signals representing the rotational speed NMG2 of the second motor generator MG2, the accelerator operation amount θACC etc. are red into the electronic control device 44 directly or via the electronic control devices 28 and 34.

It is considered to preferable to provide such a drive unit for a vehicle with, in addition to an assist operation mode in which the first motor generator MG1 (first rotary machine) is operated as a generator and the second motor generator MG2 (second rotary machine) is driven as a motor using the electrical energy generated by the first motor generator MG1 to propel the vehicle as shown in FIG. 15A, an overdrive (O/D) operation mode in which the first motor generator MG1 is driven in the reverse rotation direction as a motor and the second motor generator MG2 is operated as a generator to provide the electrical energy necessary to drive the first motor generator MG to, for example, propel the vehicle at a high speed as shown in FIG. 15B. According to the O/D operation mode, the output shaft rotational speed N_{OUT} can be significantly increased to propel the vehicle at a high speed with the engine speed NE maintained at a prescribed low speed determined based on the fuel efficiency or the like. FIGS. 15A and 15B both show the case where the automatic transmission 22 is in the high gear Hi, and the vertical outline arrows along the vertical axis S0, the vertical axis CA0, and the vertical axis S1 represent the direction of torque.

In the above O/D operation mode, however, the output of the engine 24 is transmitted from the electric differential 20 to the second motor generator MG2 via the output shaft 14 and the automatic transmission 22 and converted into electrical energy by the second motor generator MG2 functioning as a generator. Then, the first motor generator MG1 is driven in the reverse rotation direction as a motor using the electrical energy, whereby a reaction force is applied to the electric differential 20 and the output of the engine 24 is transmitted to the output shaft 14. Therefore, an energy circulation as shown in FIG. 16 occurs and causes a significant reduction in the energy efficiency, resulting in very poor fuel efficiency. The dot-and-dashed line curve in FIG. 10 represents the transmission efficiency in the O/D operation mode theoretically obtained based on the assumption that the mechanical efficiency is 100% and the electrical efficiency is 90%, and indicates that the transmission efficiency decreases at an accelerated rate in the range in which the transmission gear ratio γo(=NE/N_{OUT}) is equal to or lower than γo1, that is, in the range in which the first motor generator MG1 is driven in the reverse rotation direction. When the gear ratio of the planetary gear device 26 is defined as ρ, the transmission gear ratio γo1 is represented as 1/(1+ρ). Thus, if ρ=0.4, then γo1≈0.7. If γo≈0.4, for example, when the vehicle is running at a high speed, the transmission efficiency decreases to about 0.8.

Although not known yet, one possible solution to this problem is to provide a clutch C1 (second power transmission interrupt mechanism) that connects the second motor generator MG2 to the carrier CA0 as an input element of the electric differential 20 for transmission of power as shown in FIG. 1 so that the brakes B1 and B2 of the automatic transmission 22 can be both disengaged and the second motor generator MG2 can be connected directly to the engine 24 by engaging the clutch C1 in the O/D operation mode.

However, when the brake B1 or B2 is disengaged and the clutch C1 is engaged to switch the second motor generator MG2 from powering operation to electricity generating operation, the rotational speed NMG2 of the second motor generator MG2 changes significantly and a shock may be generated by the inertia caused by the change in the rotational speed.

### SUMMARY OF THE INVENTION

The present invention provides a drive unit for a vehicle having first and second rotary machines that reduces the shock which may occur when the rotary machines change two different operation modes from one to the other.

According to one aspect of the present invention, a drive unit for a vehicle of the present invention includes: a first rotary machine; an electric differential that controls a speed differential between an input and an output rotational speed when operation conditions of the first rotary machine connected to a reaction force element of the electric differential are controlled; a second rotary machine that transmits power to a power transmission route from an output member of the electric differential to wheels via a first power transmission interrupt mechanism; a second power transmission interrupt mechanism that connects the second rotary machine to an input member of the electric differential; and a control device. The control device switches the drive unit operation mode between a first operation mode, in which the drive unit operates with the first power transmission interrupt mechanism in a power transmitting state and the second power transmission interrupt mechanism in a power disconnected state, and a second operation mode, in which the drive unit operates with the first power transmission interrupt mechanism in a power disconnected state and the second power transmission interrupt mechanism in a power transmitting state. The operation mode is switched when the torque output from the second rotary machine is nearly 0.

In switching the operation mode from the first operation mode to the second operation mode, the control device may bring the first power transmission interrupt mechanism into a power disconnected state when the torque output of the second rotary machine becomes nearly 0, and the control device brings the second power transmission interrupt mechanism into a power transmitting state after executing a control for a rotation synchronization of the second power transmission interrupt mechanism so that the rotational speed of the second rotary machine reaches the rotational speed achieved after the operation mode is switched by an autonomous rotational speed control of the second rotary machine.

In switching the operation mode from the second operation mode to the first operation mode, the control device may bring the second power transmission interrupt mechanism into a power disconnected state when the torque output of the second rotary machine becomes nearly 0, and the control device brings the first power transmission interrupt mechanism into a disengaged state after executing a control for a rotation synchronization of the first power transmission interrupt mechanism so that the rotational speed of the second rotary machine reaches the rotational speed achieved after the operation mode is switched by an autonomous rotational speed control of the second rotary machine.

In the drive unit for a vehicle, in the first operation mode in which the drive unit for a vehicle operates with the first power transmission interrupt mechanism in a power transmitting state and the second power transmission interrupt mechanism in a power disconnected state, the input rotational speed (rotational speed of the main drive source, for example) may be freely controlled regardless of the output rotational speed of the electric differential by controlling the first rotary machine, and an assisting drive force may be generated by driving the second rotary machine as a motor. Also, in the second operation mode in which the drive unit for a vehicle operates with the first power transmission interrupt mechanism in a power disconnected state and the second power transmission interrupt mechanism in a power transmitting state, the input rotational speed (rotational speed of the main drive source, for example) may be freely controlled regardless of the output rotational speed of the electric differential by controlling the first rotary machine as in the first operation mode, and no energy circulation occurs and the energy efficiency improves when the vehicle runs with the second rotary machine being operated in power generation control, for example, because the second rotary machine is connected directly to the input member of the electric differential.

In addition, because the switching between the first operation mode and the second operation mode is performed in an operating range in which the torque of the second rotary machine is nearly 0, almost no torque variation occurs when the first and second power transmission interrupt mechanisms are brought into a power disconnected state or power transmitting state to switch the mode. Also, when the operation mode is switched, the first or second power transmission interrupt mechanism to be brought into a power disconnected state is brought into a power disconnected state, a control for a rotation synchronization of the second or first power transmission interrupt mechanism is executed so that the rotational speed of the second rotary machine reaches the rotational speed achieved after the operation mode is switched by an autonomous rotational speed control of the second rotary machine, and then the second or first power transmission interrupt mechanism to be brought into a power transmitting state is brought into a power transmitting state. Therefore, when the operation mode is switched from the first operation mode to the second operation mode and vice versa, the rotational speed of the second rotary machine does not change when the second or first power transmission interrupt mechanism is brought into power transmitting state and the shock due to inertia caused by a change in the rotational speed is reduced. As a result, the operation mode switching between the first operation mode and the second operation mode may be accomplished quickly and smoothly without causing a shock from such a torque variation.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a general configuration diagram of a hybrid drive unit to which the present invention is applied;

FIG. 2 is a view specifically illustrating the installation position of a clutch C1 in relation to motor generators MG1 and MG2 in the hybrid drive unit shown in FIG. 1;

FIG. 3 is a block diagram illustrating the functions which a control device of the hybrid drive unit shown in FIG. 1 has for a plurality of modes;

FIG. 4A is a view showing a plurality of operation modes of the hybrid drive unit shown in FIG. 1;

FIG. 4B is an operation mode switching map of the hybrid drive unit shown in FIG. 1;

FIG. 5 is a view illustrating an energy flow in the O/D operation mode shown in FIGS. 4A and 4B;

FIG. 6 is a flowchart specifically illustrating the signal processing procedure when the operation mode is switched from the assist operation mode Lo or Hi to the O/D operation mode by the operation mode switching control device shown in FIG. 3;

FIG. 7 is a flowchart specifically illustrating the signal processing which is executed when the operation mode is switched from the O/D operation mode to the assist operation mode Lo or Hi by the operation mode switching control device shown in FIG. 3;

FIG. 8 is an example of a time chart showing changes in torque, rotational speed, and hydraulic pressure that occur when the operation mode is switched from the assist operation mode Hi to the O/D operation mode according to the flowchart shown in FIG. 6;

FIG. 9A, FIG. 9B, FIG. 9C and FIG. 9D are collinear diagrams showing, in a stepwise fashion, changes in the operating conditions of various parts that occur when the operation mode is switched from the assist operation mode Hi to the O/D operation mode according to the flowchart shown in FIG. 6;

FIG. 10 is a graph of transmission efficiency in the O/D operation mode theoretically obtained with respect to the transmission gear ratio γo, shown in comparison with that in a conventional device lacking a clutch C1;

FIG. 11 is a view illustrating the relation between the torques of the first motor generator MG1 and the second motor generator MG2 and the transmission gear ratio γo;

FIG. 12 is a general configuration diagram illustrating an example of a conventional hybrid drive unit;

FIG. 13 is a collinear diagram illustrating the operation of a planetary gear device provided in a first drive force generation source of the hybrid drive unit shown in FIG. 1 and FIG. 12;

FIG. 14 is a collinear diagram illustrating a plurality of gears Lo and Hi of an automatic transmission disposed between the second motor generator MG2 and an output shaft in the hybrid drive unit shown in FIG. 1 and FIG. 12;

FIG. 15A is a collinear diagram illustrating an assist operation mode of the conventional hybrid drive unit shown in FIG. 12;

FIG. 15B is a collinear diagram illustrating an O/D operation mode of the conventional hybrid drive unit shown in FIG. 12; and

FIG. 16 is a view illustrating an energy flow in the O/D operation mode of the conventional hybrid drive unit shown in FIG. 15B.

### DETAILED DESCRIPTION OF EMBODIMENTS

The present invention is suitably applicable to a drive unit for a hybrid vehicle in which an internal combustion engine, such as a gasoline engine or diesel engine that serves as a main drive source, is connected to an input member of an electric differential. However, a drive source other than an internal combustion engine, such as an electric motor or motor generator, may be adopted as the main drive source instead.

The electric differential includes a single planetary gear device such as a single-pinion planetary gear device or double-pinion planetary gear device. The electric differential, however, may take various forms. For example, the electric differential may include a plurality of planetary gear devices, or a bevel gear type differential device may be used.

The term “rotary machine” as in a “first rotary machine” and a “second rotary machine” refers to a rotary electric machine, and a motor generator which selectively functions as an electric motor and a generator are preferably used. Depending on the embodiments of first and second operation modes, an electric motor or generator may be used as one of the rotary machines. Both an electric motor and a generator may be used for each of the first and second rotary machines.

The second rotary machine may be directly connected to an output member via a single first power transmission interrupt mechanism such as clutch, or may be connected to an output member via a transmission, as a first power transmission interrupt mechanism, which has a plurality of clutches and brakes to provide a plurality of gears with different gear ratios and a disconnected state to interrupt the transmission of power.

A second power transmission interrupt mechanism is a single clutch, for example, and is adapted to connect the second rotary machine directly to an input member of the electric differential. Various other configurations are possible, though. For example, the second power transmission interrupt mechanism may connect the second rotary machine to the input member via a gear mechanism such as a planetary gear device, and may be switched between a power transmitting state and a power disconnected state by a clutch or brake. When the second power transmission interrupt mechanism is constituted of a single clutch, it may be disposed in a compact arrangement without increasing the axial dimension of the drive unit if it is axially disposed in, for example, a dead space around a differential mechanism (planetary gear device, for example) of the electric differential disposed between the first rotary machine and the second rotary machine.

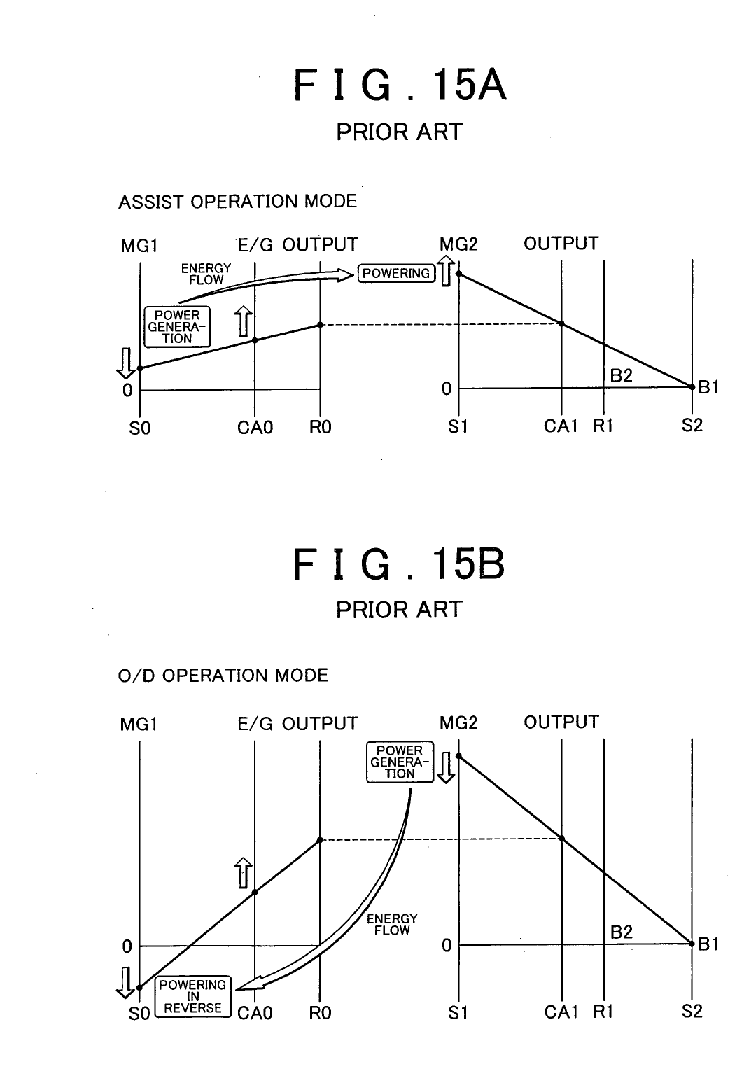

Preferably, the operating conditions of the first rotary machine and the second rotary machine in the first operation mode and the second operation mode are set such that no energy circulation occur. Even if an operation mode which causes an energy circulation as shown in FIG. 15B is set as the first operation mode or the second operation mode, the effects of the present invention may still be achieved.

The cases where the torque of the second rotary machine can become nearly 0 when the operation mode is switched includes the case where the powering torque output of the second rotary machine decreases to nearly 0 because of a change in the output amount requested by the driver (accelerator operation amount, for example), the case where, when the second rotary machine is driven as a motor using the electrical energy generated by the first rotary machine, the rotational speed of the first rotary machine becomes nearly 0 and the electrical energy becomes nearly 0 accordingly, and the case where, when the second rotary machine is driven as a motor using electrical energy from an electric storage device and the electrical energy generated by the first rotary machine, the first rotary machine is driven as a motor in the reverse rotation direction because of, for example, an increase in the vehicle speed or decrease in the output request amount and the energy from the electric storage device is consumed to drive the first rotary machine in the reverse direction until the electrical energy to the second rotary machine becomes nearly 0. Also possible is the case where, when the second rotary machine is operated as a generator to provide the electrical energy necessary to drive the first rotary machine as a motor, the powering torque output of the first rotary machine becomes nearly 0 because of, for example, a decrease in the output amount requested by the driver (accelerator operation amount, for example) and the electricity generating torque of the second rotary machine becomes nearly 0 accordingly. Some other cases are also possible.

If the predetermined mode switching conditions are satisfied, the torque of the second rotary machine may be reduced to 0 to switch modes while controlling the main drive source such as an engine and the first rotary machine to maintain the drive force requested by the driver. That is, the cases where the torque of the second rotary machine may become nearly 0 also includes the case where the main drive source, the first rotary machine and so on are controlled to deliberately reduce the torque of the second rotary machine to nearly 0, and the operating conditions of the main drive source, the first rotary machine and so on may be corrected so that the change in the torque of the second rotary machine does not affect the drive force.

The mode switching is performed in the operating range in which the torque of the second rotary machine is nearly 0 to prevent a torque variation from occurring when the first or second power transmission interrupt mechanism is switched to the power disconnected state or the power transmitting state. Therefore, the torque is not necessarily exactly 0 as long as it is so small, for example not greater than ±3N·m, preferably not greater than ±1N·m, that the shock caused by a torque variation is negligible. To avoid a busy shift when switching operation modes, a designated hysteresis (about 1 to 3N·m, for example) may be provided.

An autonomous rotational speed control of the second rotary machine when switching modes is performed when the torque of the second rotary machine is nearly 0. Therefore, it is only necessary to drive the second rotary machine to increase the rotational speed thereof, and it is only necessary to operate the second rotary machine as a generator to decrease the rotational speed thereof. When the rotational speed autonomous control is executed, the rotational speed may be quickly changed with relatively low torque because the first and second power transmission interrupt mechanisms are both in a power disconnected state.

In an embodiment of the present invention, (a) the first and second rotary machines may be a first motor generator and a second motor generator, respectively, each of which functions as both a generator and an electric motor, (b) the first motor generator is operated as a generator and the electrical energy generated by the first motor generator is used to drive the second motor generator as a motor in the first operation mode, (c) the first motor generator is operated as a generator and the electrical energy generated by the first motor generator is used to drive the second motor generator as a motor in the first operation mode, and (d) the powering torque output of the second motor generator increases or decreases depending on the amount of electrical energy obtained by operating the first motor generator as a generator, and the electricity generating torque of the second motor generator increases or decreases depending on the electrical energy consumed in driving the first motor generator as a motor.

In the above embodiment, (a) the electric differential rotatably drives the output member in the same rotational direction as that of the input member by using the first motor generator to regulate the rotational speed of a reaction force member, which is rotated in the same rotation direction as the input member, and (b) the first motor generator is either operated as a generator to reduce the rotational speed of the reaction force member in the first operation mode or is driven as a motor to rotate the reaction force member in the opposite rotation direction from that of the input member in the second operation mode. The present invention is, however, applicable to the case where (a) the electric differential rotatably drives the output member in the same rotation direction as that of the input member by regulating the rotational speed of a reaction force member which is rotated in the opposite rotation direction from the input member with the first motor generator, and (b) the first motor generator is operated as a generator to reduce the rotational speed of the reaction force member in the first operation mode, and the first motor generator is driven as a motor to rotate the reaction force member in the same rotation direction as that of the input member in the second operation mode. In other words, although the present invention is suitably applicable to the case where an output element connected to the output member is located at one end, and the rotational elements at the center and at the opposite end are one and the other of an input element and a reaction force element, in a collinear diagram of the electric differential having three rotational elements, and, in particular, to the case where the rotational element at the center is an input element and the rotational element at the other end is an reaction force element, the present invention is also applicable to the case where the rotational element at the center is an output element and the rotational elements at both ends are an input element and a reaction force element.

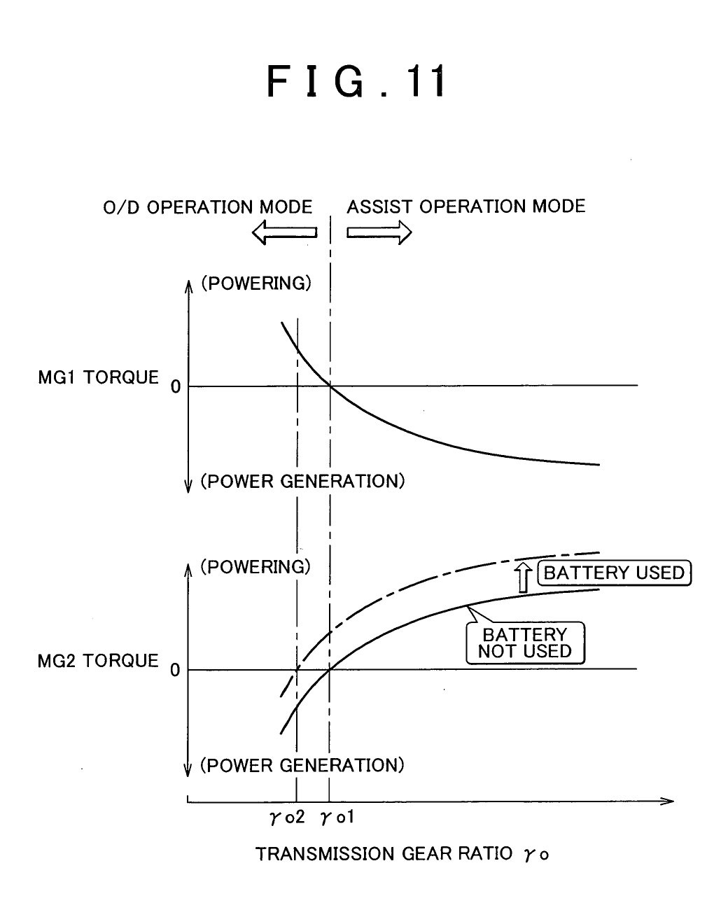

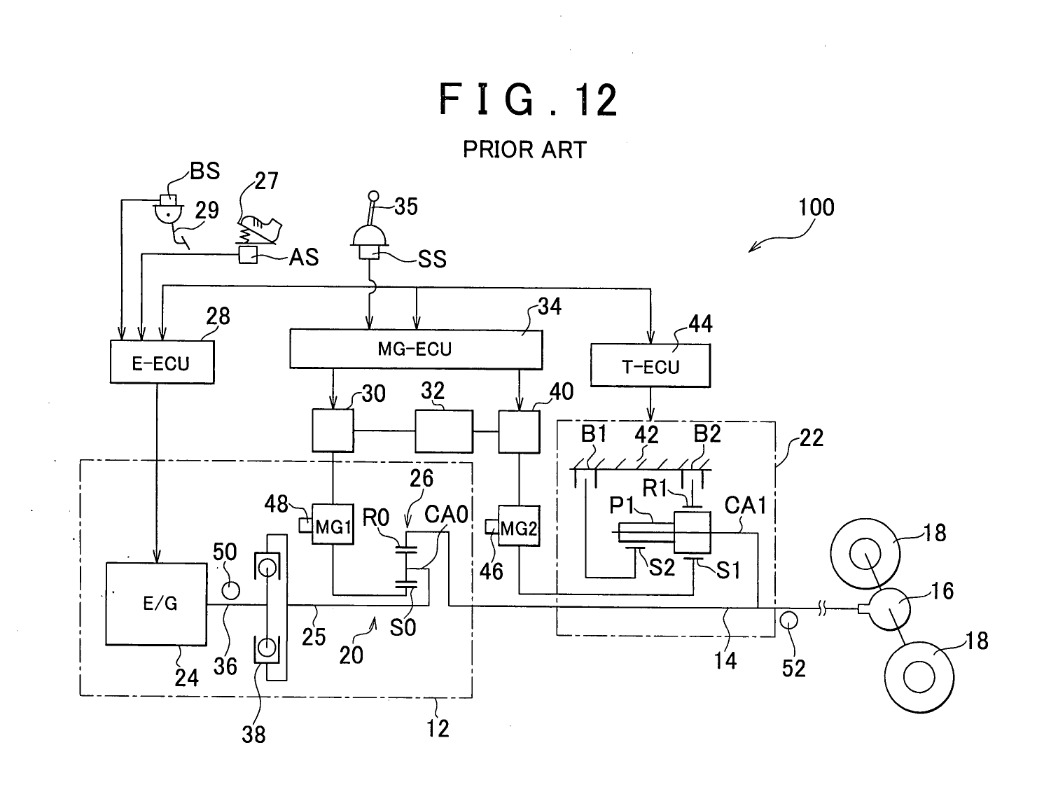

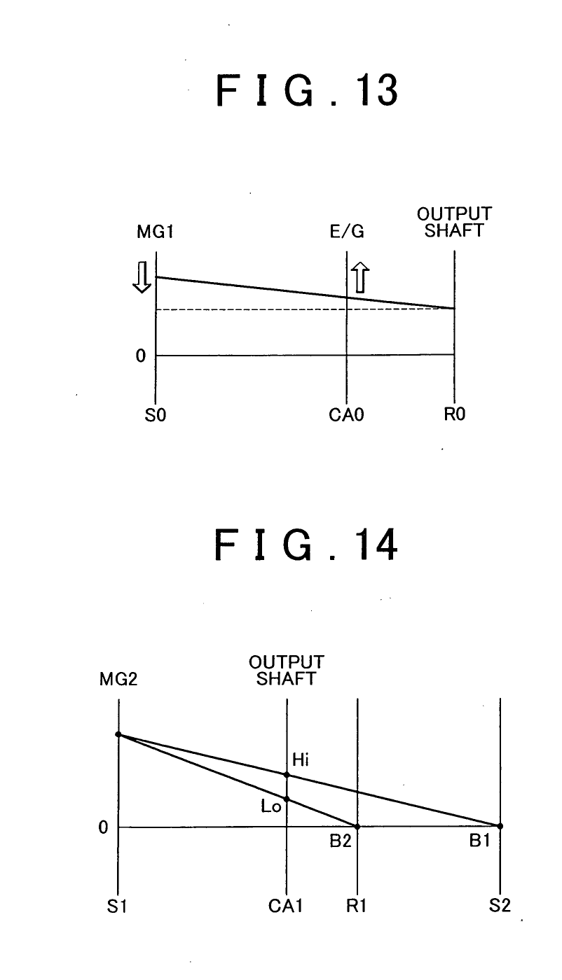

An embodiment of the present invention is described in detail below with reference to the drawings. The following embodiment is the one obtained by applying the present invention to a conventional device showing in FIG. 12, and the same components are designated by the same reference numerals and their detailed description is not repeated.

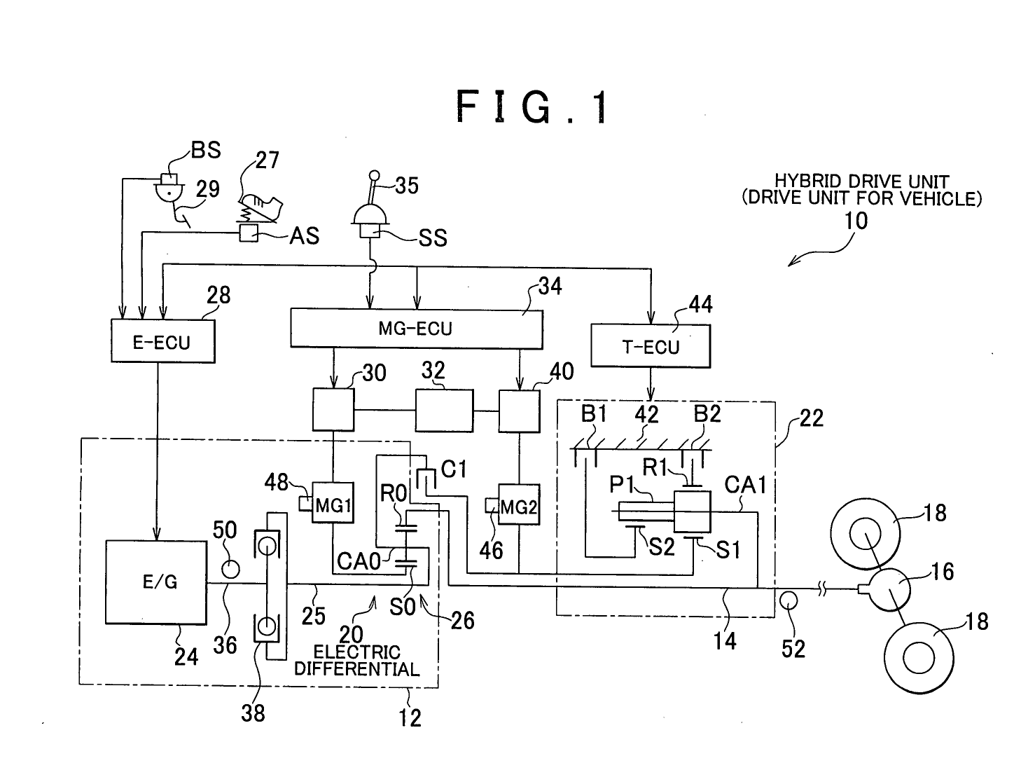

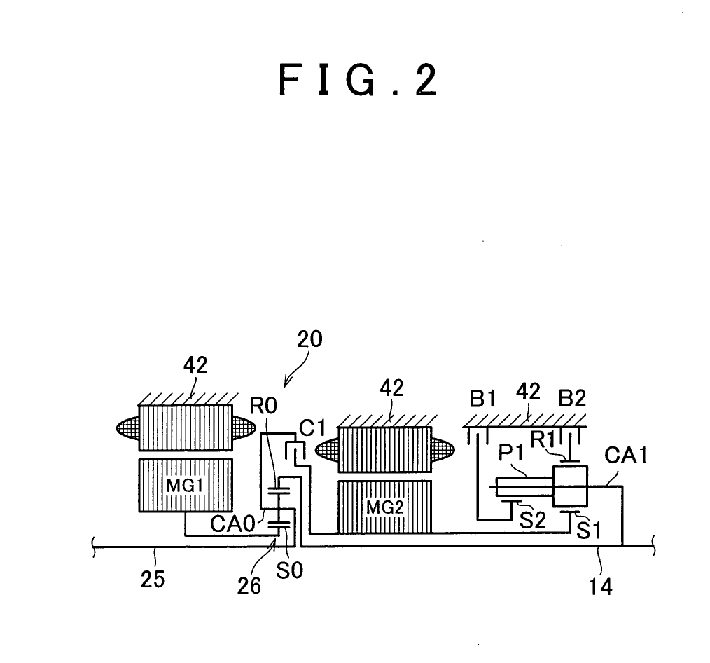

The hybrid drive unit 10 shown in FIG. 1 differs from the hybrid drive unit 100 shown in FIG. 12 in that the carrier CA0, serving as an input element of the electric differential 20, is connected to the second motor generator MG2 for transmission of power via a clutch C1, serving as a second power transmission interrupt mechanism. The clutch C1 is a hydraulic friction engagment device, and is actuated by the electronic control device 44 for shift control via a hydraulic pressure control device as in the case with the first brake B1 and the second brake B2 of the automatic transmission 22. Because the clutch C1 is axially disposed in a dead space around the planetary gear device 26, serving as a differential mechanism of the electric differential 20 disposed between the first motor generator MG1 and the second motor generator MG2 as specifically shown in FIG. 2, it is disposed in a compact arrangement without increasing the axial length of the hybrid drive unit 10.

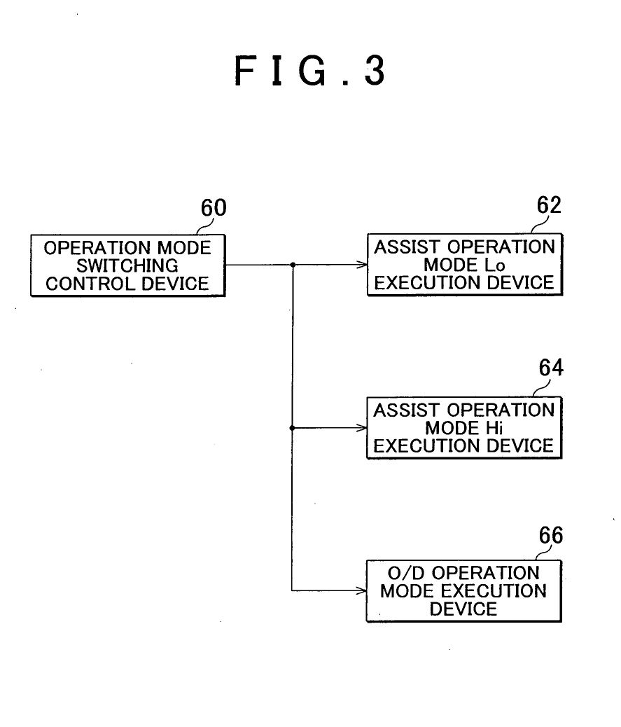

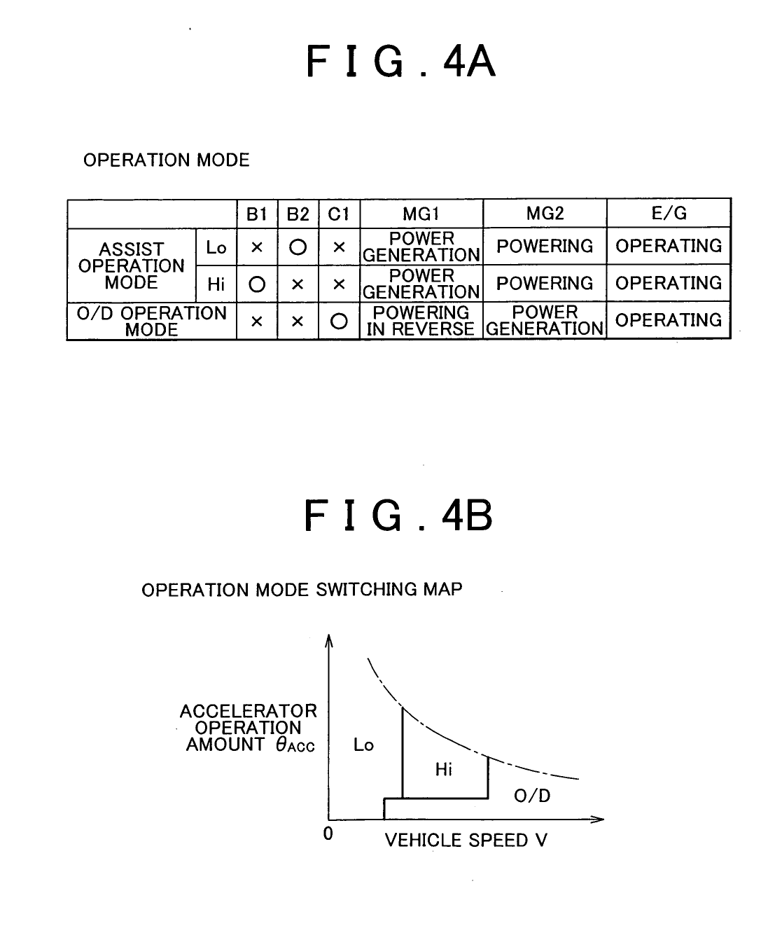

The hybrid drive unit 10 as described above has two assist operation modes Lo and Hi and an overdrive (O/D) operation mode as shown in FIGS. 4A and 4B, and the electronic control devices 28, 34, and 44 have an operation mode switching control device 60, an assist operation mode Lo execution device 62, an assist operation mode Hi execution device 64, and an O/D operation mode execution device 66 as shown in FIG. 3. The assist operation mode Lo and the assist operation mode Hi both correspond to the first operation mode, and the O/D operation mode corresponds to the second operation mode.

The function of the assist operation mode Lo execution device 62 is to propel the vehicle in the assist operation mode Lo. The assist operation mode Lo execution device 62 engages the second brake B2 to establish the low gear Lo in the automatic transmission 22 and disengages the clutch C1, drives the second motor generator MG2 as a motor to apply an assist drive force to the output shaft 14, operates the first motor generator MG1 as a generator to provide a large portion of the electrical energy necessary to drive the second motor generator MG2 as a motor, and draws electrical energy from the electric storage device 32 or charges the electric storage device 32 as needed depending on the the residual capacity SOC in the electric storage device 32. The assist operation mode Lo is executed when the vehicle speed is low as shown in FIG. 4B, and the first motor generator MG1 is driven as a generator in the same forward direction as the engine 24. The “Lo,” “Hi”, and “O/D” in FIG. 4B represent the assist operation mode Lo, the assist operation mode Hi, and the O/D operation mode, respectively.

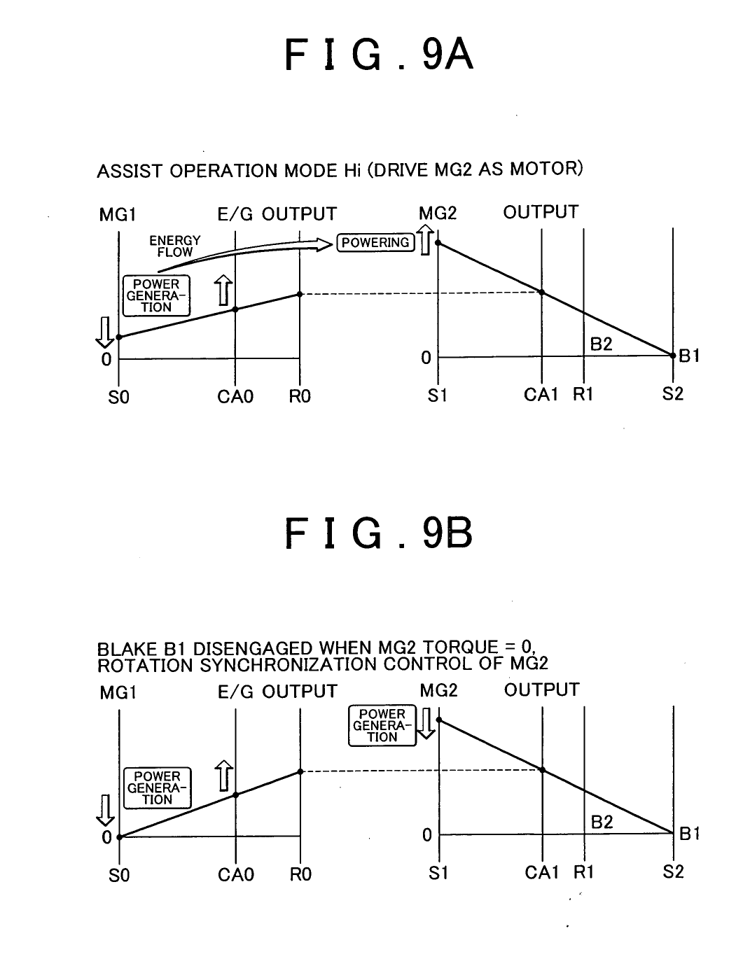

The function of the assist operation mode Hi execution device 64 is to propel the vehicle in the assist operation mode Hi. As shown in FIG. 9A, the assist operation mode Hi execution device 64 engages the first brake B1 to establish the high gear Hi in the automatic transmission 22 and disengages the clutch C1, drives the second motor generator MG2 as a motor to apply an assist drive force to the output shaft 14, operates the first motor generator MG1 as a generator to provide a large portion of the electrical energy necessary to drive the second motor generator MG2 as a motor, and draws electrical energy from the electric storage device 32 or charges the electric storage device 32 as needed depending on the the residual capacity SOC in the electric storage device 32. The assist operation mode Hi is executed when the vehicle speed is above the speed range in which the assist operation mode Lo is selected as shown in FIG. 4B, and the first motor generator MG1 is driven as a generator in the same forward direction as the engine 24.

When electrical energy is drawn from the electric storage device 32 in the assist operation mode Lo or Hi, even if the rotational speed NMG1 of the first motor generator MG1 decreases to 0 (NMG1=0) and no electrical energy is generated by the first motor generator MG1, the powering control of the second motor generator MG2 can be executed and the first motor generator MG1 is rotatably driven in the revere rotation direction as long as energy is available from the electric storage device 32.

The function of the O/D operation mode execution device 66 is to propel the vehicle in the O/D operation mode. As shown in FIG. 9D, the O/D operation mode execution device 66 engages the clutch C1 to connect the second motor generator MG2 directly to the engine 24 so that the second motor generator MG2 rotates integrally with the input shaft 25 and disengages both the first brake B1 and the second brake B2 to bring the automatic transmission 22 into a power disconnected state, operates the second motor generator MG2 as a generator and drives the first motor generator MG1 in the reverse rotation direction using the electrical energy generated by the second motor generator MG2, and draws electrical energy from the electric storage device 32 or charges the electric storage device 32 as needed depending on the the residual capacity SOC in the electric storage device 32. The O/D operation mode is executed when the vehicle speed is on higher than the speed range in which the assist operation mode Hi is executed and during low-load operation when the accelerator operation amount θACC is small as shown in FIG. 4B.

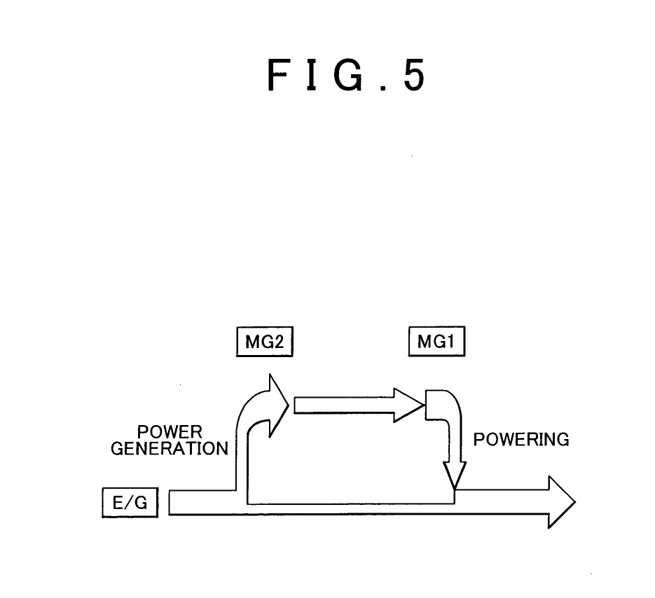

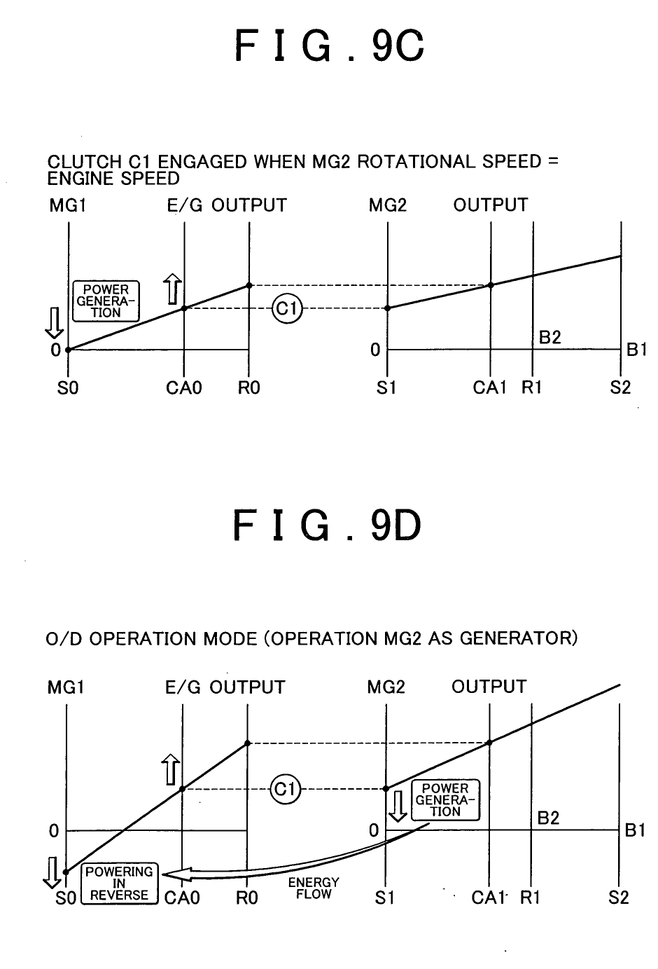

In the O/D operation mode, the output of the engine 24 is directly transmitted from the input shaft 25 to the second motor generator MG2 via the carrier CA0 and the clutch C1, and the first motor generator MG1 is driven as a motor in the reverse rotation direction, using the electrical energy generated by operating the second motor generator MG2 as a generator, to output a drive force to the output shaft 14. Therefore, an energy flow only in the forward direction without an energy circulation is formed as shown in FIG. 5. As a result, the energy efficiency improves, and the fuel efficiency during high-speed operation in the O/D operation mode and low-load operation improves. The solid line curve in FIG. 10 represents the transmission efficiency in the O/D operation mode of this embodiment theoretically obtained based on the assumption that the mechanical efficiency is 100% and the electrical efficiency is 90%, and indicates that the transmission efficiency is significantly improved as compared to the conventional O/D operation mode indicated by the dot-and-dashed line curve in the range where the transmission gear ratio γo (=NE/N_{OUT}) of the electric differential 20 is equal to or lower than γo1, that is, the first motor generator MG1 is driven in the reverse rotation direction. That is, even if the transmission gear ratio γo becomes about 0.4 during high-speed operation, the transmission efficiency is maintained at 0.9 or higher. FIG. 10 shows the transmission efficiency when the amount of charge and discharge of the electric storage device 32 is 0, and the range in which the transmission gear ratio γo is below γo1 corresponds to the O/D operation mode, as well as when the range in which the transmission gear ratio γo is greater than γo1 corresponds to the assist operation mode Hi.

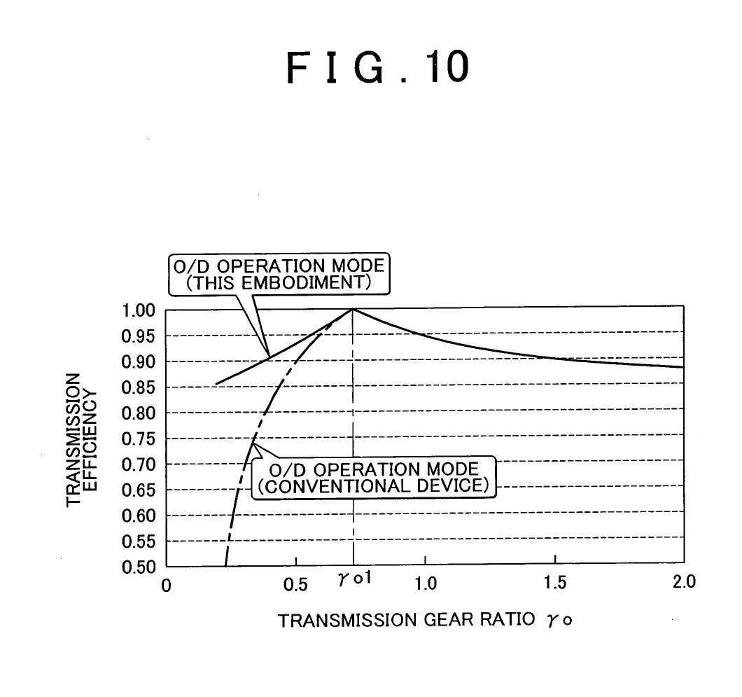

FIG. 11 is a graph showing an example of the relation between the transmission gear ratio γo and the torque output of the first motor generator MG1 and the second motor generator MG2. The solid line curves show the relation when the amount of charge and discharge of the electric storage device 32 is 0. In the assist operation mode Lo or Hi, when the transmission gear ratio γo decreases, the rotational speed NMG1 of the first motor generator MG1 becomes 0 when the transmission gear ratio γo=γo1. Then, the electricity generating torque output of the first motor generator MG1 becomes 0 and the powering torque output of the second motor generator MG2 becomes 0 accordingly. When the first motor generator MG1 is driven as a motor in the reverse rotation direction and the transmission gear ratio γo further decreases, the second motor generator MG2 is operated as a generator to provide the electrical energy necessary to drive the first motor generator MG1. That is, in this embodiment, the powering torque output and electricity generating torque of the first motor generator MG1 and the second motor generator MG2 are controlled based on the output amount requested by the driver such as the accelerator operation amount θACC, the vehicle speed V, and so on depending on the transmission gear ratio γo of the electric differential 20 as shown in FIG. 11.

The dot-and-dashed line curve in the section of the second motor generator MG2 in FIG. 11 shows the relation in the case where a specified amount of electrical energy is drawn from the electric storage device 32. Because the powering torque output of the second motor generator MG2 is increased by the amount of the electrical energy drawn from the electric storage device 32, the assist operation mode in which the second motor generator MG2 is driven as a motor is maintained even after the transmission gear ratio γo falls below γo1 and the first motor generator MG1 has started to be driven as a motor in the reverse rotation direction. The assist operation mode in this case is continued until the energy drawn from the electric storage device 32 is consumed [??] to drive the first motor generator MG1 as a motor in the reverse rotation direction and the electrical energy to the second motor generator MG2 becomes nearly 0, and the operation mode switches from the assist operation mode to the O/D operation mode when the transmission gear ratio γo becomes generally equal to γo2. The operation mode switching map shown in FIG. 4B is a basic map that is used when the amount of charge and discharge of the electric storage device 32 is 0 and is changed depending on the amount of charge and discharge of the electric storage device 32 and so on.

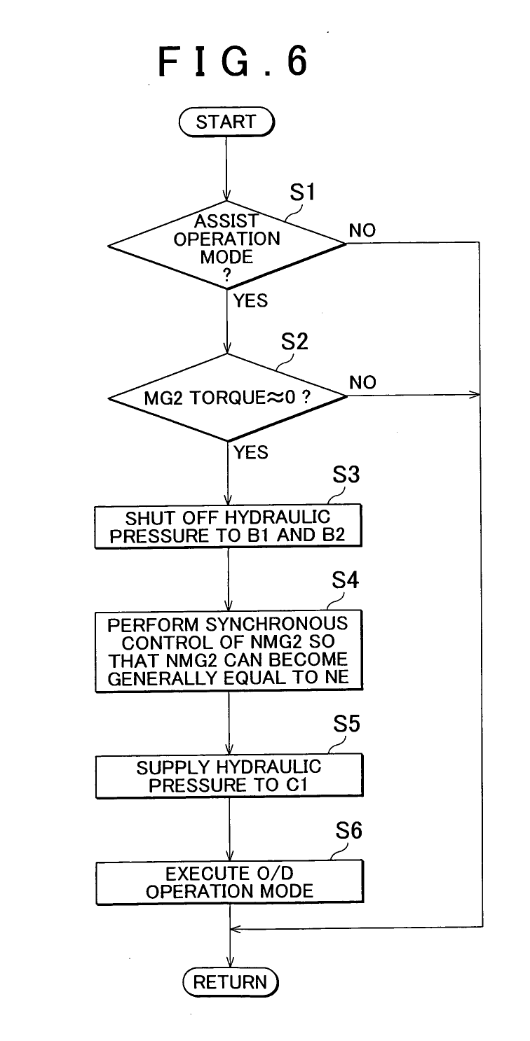

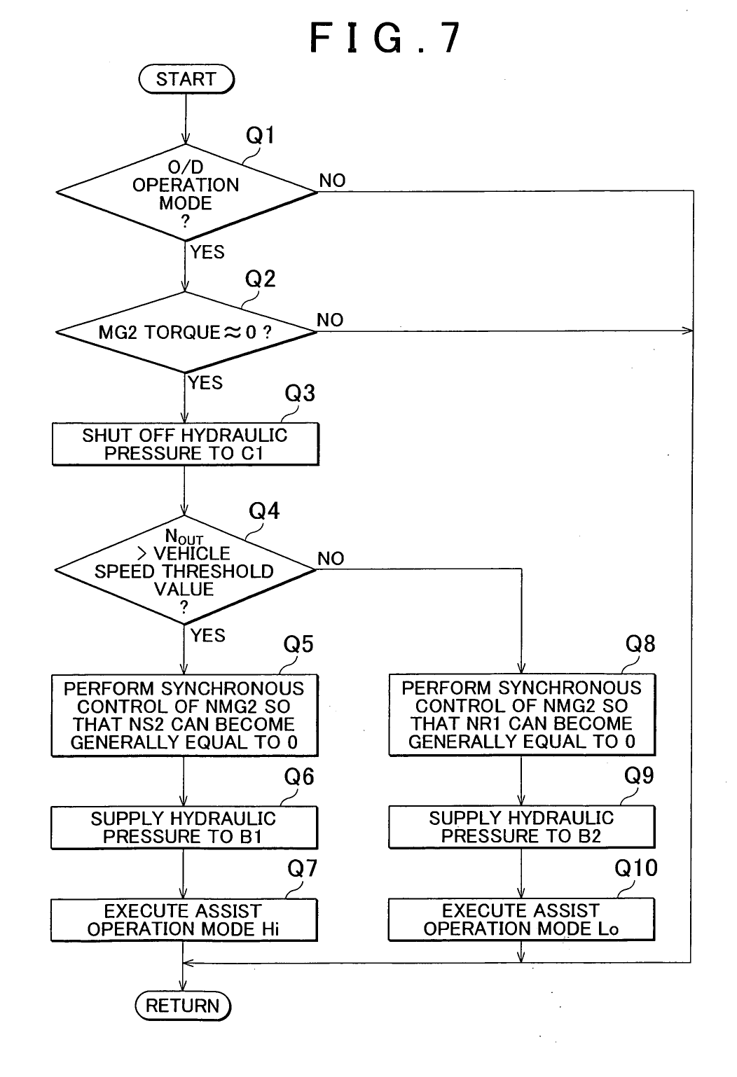

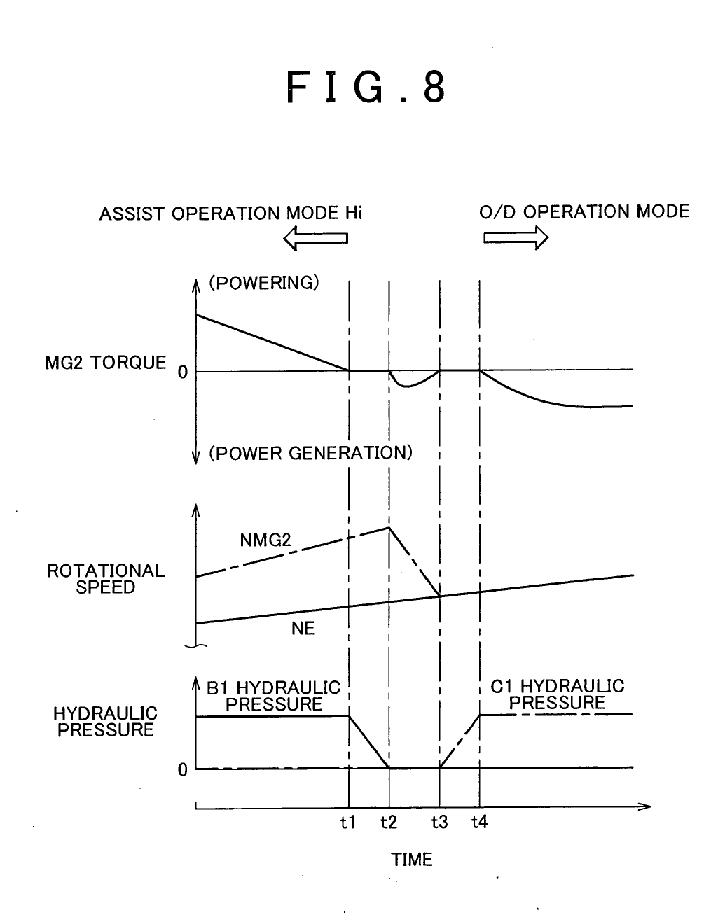

The operation mode switching control device 60 switches the operation mode according to the flowcharts shown in FIG. 6 and FIG. 7. FIG. 6 is a flowchart showing the signal processing that is executed when the operation mode is switched from the assist operation mode Lo or Hi to the O/D operation mode, and FIG. 8 is a time chart showing an example of changes in the torque output of the second motor generator MG2 (MG2 torque), the rotational speed NMG2 of the second motor generator MG2, the engine speed NE, the hydraulic pressure of the first brake B1 (B1 hydraulic pressure) and the hydraulic pressure of the clutch C1 (C1 hydraulic pressure) that occur when the operation mode is switched from the assist operation mode Hi to the O/D operation mode. FIGS. 9A to 9D are collinear diagrams showing, in a stepwise fashion, the changes in the operating conditions of various parts that occur when the operation mode is switched from the assist operation mode Hi to the O/D operation mode.

In step S1 in FIG. 6, it is determined whether the operation mode is the assist operation mode Lo or Hi based on a flag that indicates the current operation mode, the engagement and disengagement of the clutch C1 and the brakes B1 and B2 (the state of command signal to the switching valve for the hydraulic pressure circuit), the powering or electricity generating state of the motor generators MG1 and MG2 or the like. If the operation mode is the assist operation mode Lo or Hi, step S2 is executed. FIG. 9A shows the operating conditions of various parts when traveling in the assist operation mode Hi. The assist operation mode Hi execution device 64 engages the first brake B1, and operates the first motor generator MG1 as a generator and drives the second motor generator MG2 as a motor using the electrical energy generated by the first motor generator MG1.

In step S2, it is determined whether the powering torque output of the second motor generator MG2 (MG2 torque) has become nearly 0, more specifically, decreased to +1N·m, for example, as a result of a decrease in the transmission gear ratio γo due to, for example, a decrease in the rotational speed NMG1 of the first motor generator MG1 with an increase in the vehicle speed V. If the powering torque output of the second motor generator MG2 is greater than +1N·m, the current routine is immediately terminated and the assist operation mode Lo or Hi is continued. If the powering torque output of the second motor generator MG2 has become equal to or smaller than +1N·m, step S3 is executed, and the brakes B1 and B2 are both disengaged to bring the automatic transmission 22 into a disengaged state. In the next step S4, rotation synchronization control of the second motor generator MG2 is executed so that the rotational speed NMG2 reaches the rotational speed that it should reach after the mode switching, i.e., become generally equal to the engine speed NE. Because the rotational speed NMG2 becomes higher than the engine speed NE according to the transmission gear ratio γs of the automatic transmission 22 in the assist operation mode Lo or Hi, the second motor generator MG2 is operated as a generator to reduce its rotational speed NMG2. In this state, because no assist drive force is obtained from the second motor generator MG2 and because the rotation of the sun gear S0 is restrained as a result of operating the first motor generator MG1 as a generator or as a motor in the reverse rotation direction, a prescribed drive force is generated based on the output of the engine 24. In FIG. 8, the time t1 is the time when the MG2 torque reaches nearly 0 and YES is selected in step S2, and disengagement of the first brake B1 is started, and the time t2 is the time when the hydraulic pressure of the first brake B1 has decreased until the first brake B1 is fully disengaged and the second motor generator MG2 starts operation as a generator. FIG. 9B shows a state in which the MG2 torque has become nearly 0, the first brake B1 has disengaged and the second motor generator MG2 has started operation as a generator.

Next, in step S5, it is determined whether the rotational speed NMG2 of the second motor generator MG2 has become generally equal to the engine speed NE as a result of the rotation synchronization control in step S4. If NMG2≈NE, the clutch C1 is engaged. Then, when the engagement of the clutch C1 is completed, the operation mode switches to the O/D operation mode to and the O/D operation mode execution device 66 executes the O/D operation mode in step S6. In FIG. 8, the time t3 is the time when NMG2≈NE and the engagement of the clutch C1 is started, and the time t4 is the time when engagement of the clutch C1 is completed and the operation mode switches to the O/D operation mode. FIG. 9C shows the state in which NMG2≈NE and the clutch C1 has been engaged, and FIG. 9D shows the state in which the O/D operation mode is executed, and the second motor generator MG2 is operated as a generator and the first motor generator MG1 is driven as a motor in the reverse rotation direction using the electrical energy generated by the second motor generator MG2.

FIG. 7 is a flowchart showing the signal processing that is executed when the operation mode switches from the O/D operation mode to either the assist operation mode Lo or Hi. In step Q1, it is determined whether the operation mode is the O/D operation mode in a manner to that of step S1. If the operation mode is the O/D operation mode, step Q2 is executed. In step Q2, it is determined whether the electricity generating torque output of the second motor generator MG2 (MG2 torque) has become nearly 0, more specifically, has decreased to −1N·m, for example, as a result of an increase in the transmission gear ratio γo due to, for example, a decrease in the rotational speed NMG1 of the first motor generator MG1 in the reverse rotation direction (an approach to a rotational speed of 0) when the vehicle speed decreases. If the electricity generating torque of the second motor generator MG2 is smaller than −1N·m, the current routine is immediately terminated and the O/D operation mode is continued. If the electricity generating torque of the second motor generator MG2 is equal to or greater than −1N·m, step Q3 is executed, and the clutch C1 is disengaged. That is, if the state has changed from that shown in FIG. 9D to the state shown in FIG. 9C, the clutch C1 is disengaged.

In the next step Q4, it is determined whether the output shaft rotational speed N_{OUT} corresponding to the vehicle speed V is higher than a shifting threshold value. If N_{OUT}>the shifting threshold value, i.e., the vehicle is running at an intermediate-high speed, step Q5 and the subsequent steps are executed to switch the operation mode to the assist operation mode Hi. If N_{OUT}≦the shifting threshold value, i.e., the vehicle is running at a low speed, step Q8 and the subsequent steps are executed to switch the operation mode to the assist operation mode Lo. In step Q5, the rotation synchronization control of the second motor generator MG2 is executed so that the rotational speed NMG2 of the second motor generator MG2 reaches the rotational speed that it should reach after the mode switching, that is, the rotational speed NS2 of the second sun gear S2 may be reduced to nearly 0 so that the high gear Hi may be established as shown in FIG. 9B. More specifically, a synchronous rotational speed for the second motor generator MG2 is obtained by multiplying the output shaft rotational speed N_{OUT} by a transmission gear ratio γsh of the high gear Hi. Because the synchronous rotational speed is higher than the engine speed NE, the second motor generator MG2 is driven as a motor in the forward rotation direction to increase its rotational speed NMG2. In this state, because no assist drive force is obtained from the second motor generator MG2 and because the rotation of the sun gear S0 is restrained as a result of the operation of the first motor generator MG1 as a generator or as a motor in the reverse rotation direction, a target drive force is generated based on the output of the engine 24.

In the next step Q6, it is determined whether the rotational speed NMG2 of the second motor generator MG2 has reached the synchronous rotational speed. If the synchronous rotational speed has been reached, the first brake B1 is engaged to establish the high gear Hi. When the the first brake B1 is engaged, the operation mode is switched to the assist operation mode Hi, and the assist operation mode Hi execution device 64 executes the assist operation mode Hi in step Q7.

Step Q8 is executed if the result in step Q4 is NO”. The rotation synchronization control of the second motor generator MG2 is executed so that the rotational speed NMG2 of the second motor generator MG2 reaches the rotational speed that it should reach after the mode switching, that is, the rotational speed NR1 of the ring gear R1 is reduced to nearly 0 so that the low gear Lo can be established. More specifically, a synchronous rotational speed for the second motor generator MG2 is obtained by multiplying the output shaft rotational speed N_{OUT} by the transmission gear ratio γs1 of the low gear Lo. Because the synchronous rotational speed is higher than the engine speed NE, the second motor generator MG2 is driven as a motor in the forward rotation direction to increase its rotational speed NMG2. In this state, because no assist drive force is obtained from the second motor generator MG2 and because the rotation of the sun gear S0 is restrained as a result of the operation of the first motor generator MG1 as a generator or as a motor in the reverse rotation direction, a target drive force is generated based on the output of the engine 24.

In the next step Q9, it is determined whether the rotational speed NMG2 of the second motor generator MG2 has reached the synchronous rotational speed. Once the synchronous rotational speed has been reached, the second brake B2 is engaged to establish the low gear Lo. When the the second brake B2 is engaged, the operation mode is switched to the assist operation mode Lo and the assist operation mode Lo execution device 62 executes the assist operation mode Lo in step Q10.

As described above, in the hybrid drive unit 10 of this embodiment, when the assist operation mode Hi or assist operation mode Lo is established by engaging the brake B1 or B2 and disengaging the clutch C1, and the engine speed NE may be freely adjusted regardless of the output shaft rotational speed N_{OUT} by operating the first motor generator MG1 as a generator and generating an assisting drive force by driving the second motor generator MG2 as a motor using the electrical energy generated by the first motor generator MG1. Also, when the O/D operation mode is established by disengaging both the brakes B1 and B2 and engaging the clutch C1, the engine speed NE may be freely adjusted regardless of the output shaft rotational speed N_{OUT} by driving the first motor generator MG1 as a motor in the reverse rotation direction and operating the second motor generator MG2 as a generator to provide the electrical energy necessary to drive the first motor generator MG1 as a motor.

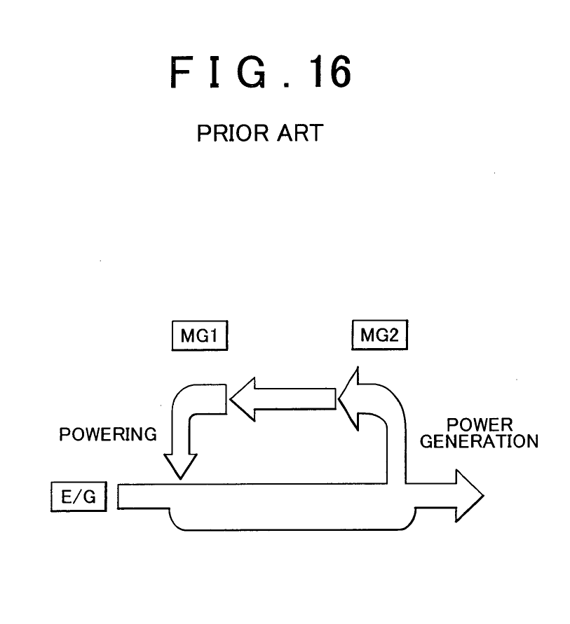

In this case, the second motor generator MG2 is connected directly to the carrier CA0 of the electric differential 20 via the clutch C1, and the output of the engine 24 is directly transmitted from the input shaft 25 to the second motor generator MG2 via the carrier CA0 and the clutch C1 in the O/D operation mode. Then, the first motor generator MG1 is driven as a motor in the reverse rotation direction using the electrical energy generated by operating the second motor generator MG2 as a generator to output a drive force to the output shaft 14. Therefore, an energy flow only in the forward direction without an energy circulation is formed as shown in FIG. 5, and both the energy efficiency and the fuel efficiency in high speed operation in the O/D operation mode, as well as low-load operation, are improved as compared to the case where an energy circulation occurs as shown in FIG. 16.

In this embodiment, because switching between the assist operation mode Lo or Hi and the O/D operation mode is performed in the operating range in which the torque of the second motor generator MG2 is nearly 0, almost no torque variation occurs when the brakes B1 or B2 and the clutch C1 are engaged or disengaged to switch the operation mode. Also, when the operation mode is switched, the brake B1 or B2 or the clutch C1 to be brought into a power disconnected state is disengaged (step S3, Q3), rotation synchronization control of the second motor generator MG2 is executed so that the second motor generator MG2 functions as a motor or a generator and reaches the rotational speed that it should reach after the mode switching (step S4, Q5, Q8), and then the brake B1 or B2 or the clutch C1 to be brought into a power transmitting state is engaged (step S5, Q6, Q9). Therefore, if the brake B1 or B2 or the clutch C1 is engaged, the rotational speed NMG2 of the second motor generator MG2 does not change and the shock due to inertia caused by a change in the rotational speed is reduced. As a result, switching modes between the assist operation mode Lo or Hi and the O/D operation mode may be accomplished quickly and smoothly, without causing generating a shock due to a torque variation.

While one embodiment of the present invention has been described in detail with reference to the drawings, this is merely an example embodiment and the present invention may be embodied in a variety of forms including various modifications and improvements based on the knowledge of those skilled in the art. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

What is claimed is:

1. A drive unit for a vehicle, comprising;
a first rotary machine;
an electric differential that controls a speed differential between an input and an output rotational speed when operation conditions of the first rotary machine connected to a reaction force element of the electric differential are controlled;
a second rotary machine that transmits power to a power transmission route from an output member of the electric differential to wheels via a first power transmission interrupt mechanism;
a second power transmission interrupt mechanism that connects the second rotary machine to an input member of the electric differential; and
a control device that switches the drive unit operation mode between a first operation mode, in which the drive unit operates with the first power transmission interrupt mechanism in a power transmitting state and the second power transmission interrupt mechanism in a power disconnected state, and a second operation mode, in which the drive unit operates with the first power transmission interrupt mechanism in a power disconnected state and the second power transmission interrupt mechanism in a power transmitting state,
wherein the operation mode is switched when the torque output from the second rotary machine is nearly 0.

2. The drive unit for a vehicle according to claim 1,
wherein, in switching the operation mode from the first operation mode to the second operation mode, the control device brings the first power transmission interrupt mechanism into a power disconnected state when the torque output of the second rotary machine becomes nearly 0, and the control device brings the second power transmission interrupt mechanism into a power transmitting state after executing a control for a rotation synchronization of the second power transmission interrupt mechanism so that the rotational speed of the second rotary machine reaches the rotational speed achieved after the operation mode is switched by an autonomous rotational speed control of the second rotary machine.

3. The drive unit for a vehicle according to claim 1,
wherein, in switching the operation mode from the second operation mode to the first operation mode, the control device brings the second power transmission interrupt mechanism into a power disconnected state when the torque output of the second rotary machine becomes nearly 0, and the control device brings the first power transmission interrupt mechanism into a disengaged state after executing a control for a rotation synchronization of the first power transmission interrupt mechanism so that the rotational speed of the second rotary machine reaches the rotational speed achieved after the operation mode is switched by an autonomous rotational speed control of the second rotary machine.

4. The drive unit for a vehicle according to claim 1,
wherein the control device operates the first rotary machine as a generator and drives the second rotary machine as a motor in the first operation mode.

5. The drive unit for a vehicle according to claim 4, wherein the first power transmission interrupt mechanism comprises:
a first brake; and
a second brake, and wherein the control device disengages the first brake and engages the second brake to provide a transmission gear ratio for low-speed running in the first operation mode.

6. The drive unit for a vehicle according to claim 5,
wherein the control device engages the first brake and disengages the second brake to provide a transmission gear ratio for high-speed running in the first operation mode.

7. The drive unit for a vehicle according to claim 1,
wherein the control device drives the first rotary machine as a motor and operates the second operation mode as a generator.
